(19) United States
(12) Patent Application Publication
(10) Pub. No.: US 2002/0158154 A1
(43) Pub. Date: Oct. 31, 2002

(54) Showerhead

(76) Inventor: Chin-Tsai Lee, Changhua Hsien (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/845,892

(22) Filed: Apr. 30, 2001

(51) Int. Cl. B05B 1/14

(52) U.S. Cl. 239/548

(57) ABSTRACT

A showerhead has a top adapted to be attached to a pipe and includes a face having multiple through hole. A flexible stud is mounted in each of the through holes in the face of the showerhead. Each of the studs has a diameter greater than that of the through hole in the showerhead. The stud is flexible and has an exterior annular groove defined to be mounted in the periphery of a through hole to hold the stud on the face of the showerhead. A longitudinal passage is defined through the stud and to allow water to discharge from the showerhead. The user can break up and flush out the impurities formed on the inner periphery of the passage by flipping the stud to keep the passage open because the stud is flexible.

### BACKGROUND OF THE INVENTION

1. Field of the Invention

The present invention relates to a showerhead, and more particularly to a showerhead that has multiple flexible stubs mounted on the face of the showerhead.

2. Description of Related Art

With reference to FIGS. 4 and 5, a conventional showerhead (33) in accordance with the prior art is screwed onto a thread (32) on the end of a pipe (31) that is adapted to be mounted on a wall (30) and connected to a water source. Multiple outlets (35) are defined in the face (34) of the showerhead (33) to allow water to spray out of the showerhead (33).

If the outlet (35) in the conventional showerhead (33) is large, water flows from the showerhead (33) as a solid stream rather than a spray when the water pressure is low. In such a condition, the showerhead (33) does not perform its intended purpose. If the outlet (35) of the conventional showerhead (33) is small, the mentioned disadvantage is mitigated. However, the impurities in water may build up on the periphery of the outlet (35), day after day, and some or all of the outlets (35) may be closed by the impurities in water.

With reference to FIG. 6, another conventional showerhead (40) was developed to easily unplug clogged outlets. The improved conventional showerhead (40) includes a face (41) having multiple threaded holes (42) defined and extending through the face (41) of the showerhead (40). Multiple studs (43) are mounted on the face (41) of the showerhead (40). The stud (43) has a threaded nipple (44) extending from one end to be screwed into the threaded hold (42) in the face (40) and a passage (43) defined through the stud (43) to allow water to discharge from the showerhead (40). For easily manufacturing and forming the threaded nipple (44), the stud (43) is usually made of metal or hard material. With such a configuration, each of the studs (43) can be removed from the showerhead (40) to remove the impurities built up on the inner periphery of the passage (45) by a tool such as a needle. It is a tedious work and takes a lot of time.

The present invention has arisen to mitigate and/or obviate the disadvantages of the conventional showerhead.

### SUMMARY OF THE INVENTION

The main objective of the present invention is to provide an improved showerhead. The stud of the present invention is flexible and has a groove defined to be mounted in and clamp a through hole defined in the face of the showerhead. A longitudinal passage is defined through the stud to allow water to discharge from the showerhead. Since the impurities that build up in the passage tend to be very brittle, a user can break up the impurities deposited on the inner periphery of the passage by simply flexing the studs. The water discharged from the showerhead will flush the impurities out of the passages and keep the passage open.

Further benefits and advantages of the present invention will become apparent after a careful reading of the detailed description with appropriate reference to the accompanying drawings.

### BRIEF DESCRIPTION OF THE DRAWINGS

FIG. 1 is a partially exploded perspective view of a showerhead in accordance with the present invention;

FIG. 2 an enlarged cross-sectional side plan view of the face of the showerhead in FIG. 1;

FIG. 3 an enlarged operational cross-sectional side plan view of the face of the showerhead in FIG. 1;

FIG. 4 is a side plan view of a conventional showerhead in accordance with the prior art;

FIG. 5 is an enlarged cross-sectional side plan view face of the conventional showerhead in FIG. 4; and

FIG. 6 is an enlarged cross-sectional side plan view of the face of another embodiment of a conventional showerhead in accordance with the prior art.

### DETAILED DESCRIPTION OF THE INVENTION

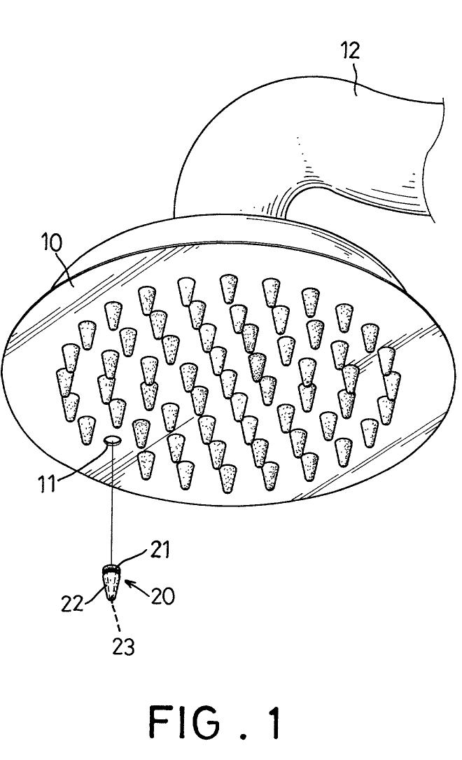

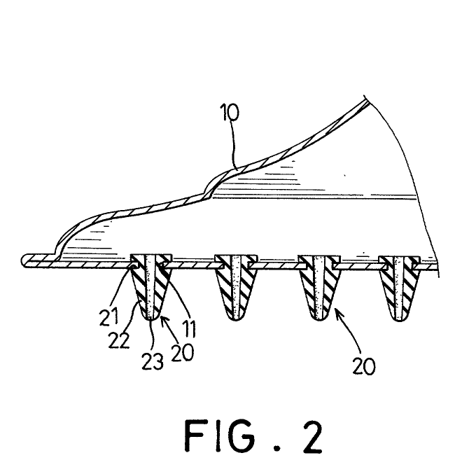

With reference to the drawings and initially to FIGS. 1 and 2, a showerhead (10) in accordance with the present invention has a top adapted to be mounted on a pipe (12) and a face having multiple through holes (11) defined therein. A flexible stud (20) is partially received in each through hole (11) in the face of the showerhead (10). Each of the studs (20) has a diameter greater than that of each of the through holes (11) in face of the showerhead (10). The stud (20) includes a first end having an exterior annular groove (21) defined to correspond to the dimensions of the through holes (11) in the face of the showerhead (10) and a second end having a protrusion (22) extending down from the stud (20) relative to the face. A longitudinal passage (23) is centrally defined in the stud (20) and extends through the stud (20) to communicate with the inner periphery of the showerhead. The first end of the stud (20) is inserted into the through hole (11) in the face of the showerhead (10), and the groove (21) is securely mounted in the periphery of the through hole (11) to hold the stud (20) on the showerhead (10).

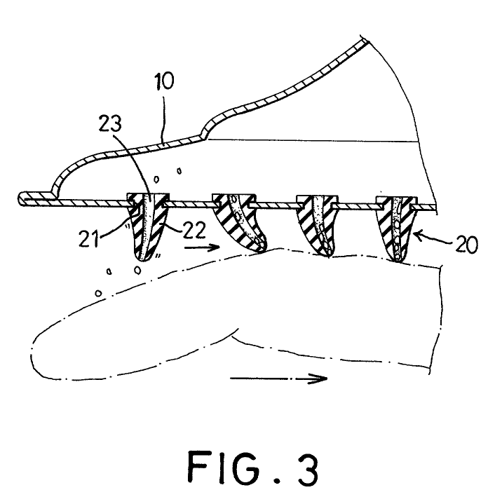

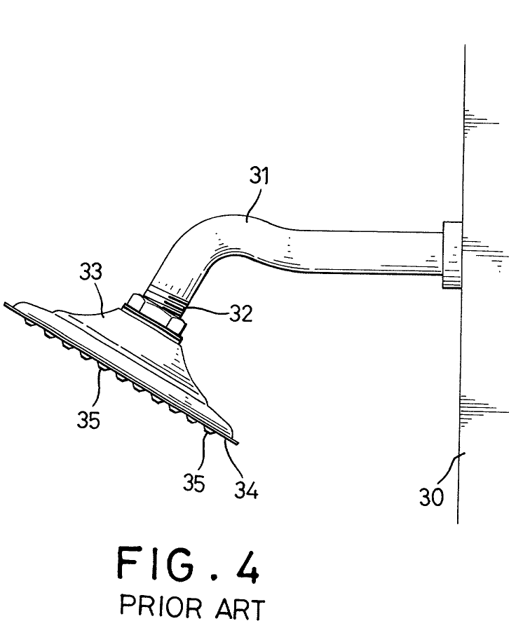

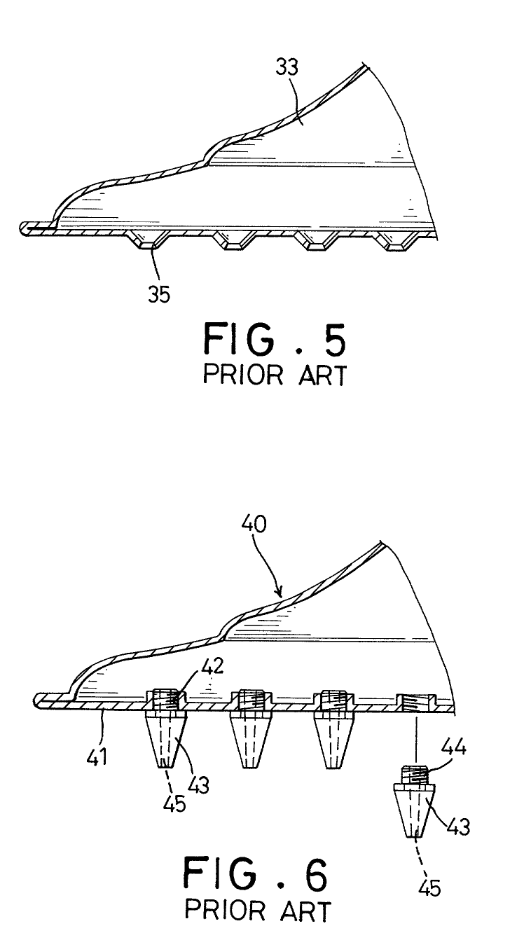

With reference to FIG. 3, the user can bend the protrusion (22) to clean the passage (23) when impurities adhere to the inner periphery of the passage (23) of the stud (20) because the stud (20) is flexible. It is convenient and takes very little time.

Although the invention has been explained in relation to its preferred embodiment, it is to be understood that many other possible modifications and variations can be made without departing from the spirit and scope of the invention as hereinafter claimed.

What is claimed is:

1. A showerhead comprising:
a top adapted to be attached to a pipe;
a face having multiple through holes defined therein; and
a stud inserted into and partially received in each of the through hole, the stud having an exterior annular groove defined to receive an inner periphery of the through hole, a protrusion extending downward relative to the face from the stud, and a longitudinal passage centrally defined in the stud and extending through the stud to communicate with an inner periphery of the showerhead to allow water to discharge from the showerhead.
